(19) United States
(12) Patent Application Publication
(10) Pub. No.: US 2007/0166022 A1
(43) Pub. Date: Jul. 19, 2007

(54) Camera module and electric device using the same

(75) Inventor: Dah-Prong Lai, Taipei (TW)

Correspondence Address: BACON & THOMAS, PLLC, 625 SLATERS LANE, FOURTH FLOOR, ALEXANDRIA, VA, 22314, US

(73) Assignee: ASUSTek COMPUTER INC., Taipei (TW)

(21) Appl. No.: 11/652,637

(22) Filed: Jan. 12, 2007

(30) Foreign Application Priority Data
Jan. 19, 2006 (TW) 95102123

(51) Int. Cl. G03B 3/10

(52) U.S. Cl. 396/133

(57) ABSTRACT

A camera module and an electric device using the same are provided. The camera module includes a lens, a voice coil motor and a magnetic element. The voice coil motor includes a movable wire-ring part and a magnetic fixed part. The movable wire-ring part clamps the lens and has an elastic element. The magnetic fixed part is disposed around the movable wire-ring part. As an electric current is inputted into the movable wire-ring part, the voice coil motor generates a pushing force for pushing the movable wire-ring part to shift along a first direction, meanwhile, the elastic element imposes an elastic restoring force onto the movable wire-ring part along the reverse direction of the first direction, and the magnetic element imposes a magnetic force onto the movable wire-ring part along the first direction.

This application claims the benefit of Taiwan application Serial No. 095102123, filed Jan. 19, 2006, the subject matter of which is incorporated herein by reference.

### BACKGROUND OF THE INVENTION

1. Field of the Invention

The invention relates in general to a camera module and an electric device using the same, and more particularly to a camera module driving a lens to move towards an opening by a magnetic element so as to save power and an electric device using the same.

2. Description of the Related Art

In everyday life, the camera module has been widely applied in a variety of electric devices such as camera, video recorder, mobile phone, notebook computer, security monitor and web visual devices. The camera module is for retrieving the dynamic or static image of an article, and is integrated with an electric device for further processing such as image processing or image storage. Availed by the electric devices, people can hold video conference, record images or communicate with live image. The electric devices indeed bring great convenience and funs to people.

The conventional camera module includes a housing, a lens, a voice coil motor (VCM) and an elastic element. The camera module is disposed above a sensing unit. The light passes through the camera module to be focused on the sensing unit. The lens is for gathering or diversify the light for the light to be focused the sensing unit. The elastic element is disposed between the housing and the lens to elastically clamp the lens. The camera module appropriately adjusts the position of the lens with respect to the sensing unit by the voice coil motor according to the position or magnification of the article. The voice coil motor includes a magnet and a movable wire-ring part. The magnet provides several magnetic lines perpendicular to a conducting coil disposed on the movable wire-ring part. The magnet is fixed on the housing. The movable wire-ring part for clamping the lens is flexibly disposed in the housing. As the movable wire-ring part conducts an electric current, the electric current and the magnetic lines form a pushing force. The lens can be shifted with respect to the sensing unit by the pushing force provided by the voice coil motor. As the lens is moving, the elastic element forms and imposes an elastic restoring force on the lens at the same time. When the pushing force and the elastic restoring force are balanced, the lens can be appropriately shifted to a pre-determined position with respect to the sensing unit.

When the lens reaches a larger shift, the elastic element results in a larger elastic deformation accordingly and the elastic restoring force is also larger. The voice coil motor must conduct a larger electric current for generating a larger pushing force to balance the elastic restoring force. Hence, the power consumption of the voice coil motor is uaually large. Therefore, how to reduce power consumption is an imminent issue to be resolved.

### SUMMARY OF THE INVENTION

It is therefore an object of the invention to provide a camera module and an electric device using the same. A magnetic element generates a magnetic force to shift the lens towards the opening, such that the electric current required for generating the same pushing force is reduced, hence saving power consumption.

The invention achieves the above-identified object by providing a camera module. The camera module includes a lens, a voice coil motor and a magnetic element. The voice coil motor includes a movable wire-ring part and a magnetic fixed part. The movable wire-ring part clamps the lens and has an elastic element. The magnetic fixed part is disposed around the movable wire-ring part. There is a magnetic force generated between the magnetic element and the elastic element. As an electric current is inputted into the movable wire-ring part, the voice coil motor generates a pushing force for pushing the movable wire-ring part to move along a first direction, meanwhile, the elastic element imposes an elastic restoring force onto the movable wire-ring part along the reverse direction of the first direction, and the magnetic element imposes a magnetic force onto the movable wire-ring part along the first direction.

The invention achieves another object by providing an electric device. The electric device includes a camera module, a sensing unit and a storage unit. The camera module includes a lens, a voice coil motor and a magnetic element. The voice coil motor includes a movable wire-ring part and a magnetic fixed part. The movable wire-ring part clamps the lens and has an elastic element. The magnetic fixed part is disposed around the movable wire-ring part. There is a magnetic force generated between the magnetic element and the elastic element. The sensing unit is disposed opposite to the lens. The external light passes through the lens and forms an image on the sensing unit. The storage unit is electrically connected to the sensing element for storing the image. As an electric current is inputted into the movable wire-ring part, the voice coil motor generates a pushing force for pushing the movable wire-ring part to shift along the first direction, meanwhile, the elastic element imposes an elastic restoring force onto the movable wire-ring part along a reverse direction of the first direction, and the magnetic element imposes a magnetic force onto the movable wire-ring part along the first direction.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a 3-D perspective of a camera module according to a first embodiment of the invention;

FIG. 2 is an upward view of the camera module of FIG. 1;

FIG. 3 is a cross-sectional view of the camera module of FIG. 1 viewed along the cross-sectional line 2-2′;

FIG. 4 shows a turned-on state of the voice coil motor of the camera module of FIG. 3; and

FIG. 5 is a block diagram of an electric device according to a second embodiment of the invention.

### DETAILED DESCRIPTION OF THE INVENTION

### First Embodiment

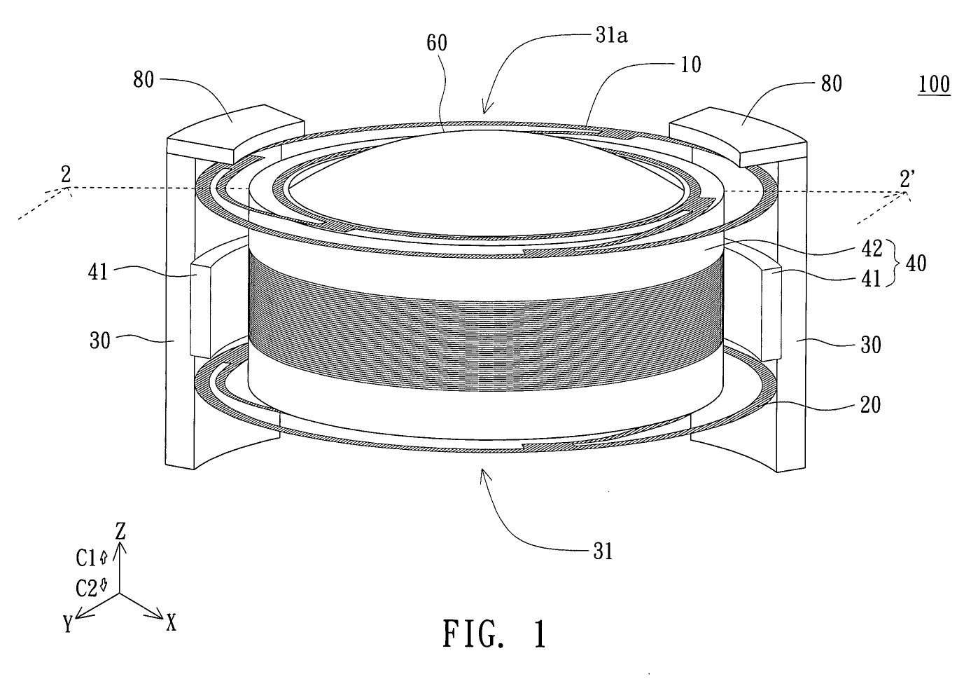

Referring to FIG. 1, a 3-D perspective of a camera module according to a first embodiment of the invention is shown. The camera module 100 includes a housing 30, a lens 60, an elastic element, a voice coil motor 40 and a magnetic element 80. The lens is exemplified by a lens 60 in the present embodiment of the invention. However, the lens can also be exemplified by a lens group composed of several pieces of lens, and the number of lens is not for limiting the scope of technology of the invention. The elastic element is exemplified by a first elastic plate 10. The housing 30 has an accommodation space 31 with an opening 31a. The voice coil motor 40 includes a movable wire-ring part 42 and a magnetic fixed part 41. The movable wire-ring part 42 flexibly coupled to the housing 30 via the first elastic plate 10 is disposed in the accommodation space 31 for clamping the lens 60. The magnetic fixed part 41 disposed around but interspaced with the movable wire-ring part 42 is fixed on the inner wall of the housing 30. The magnetic element 80 is disposed at the opening 31a of the housing 30.

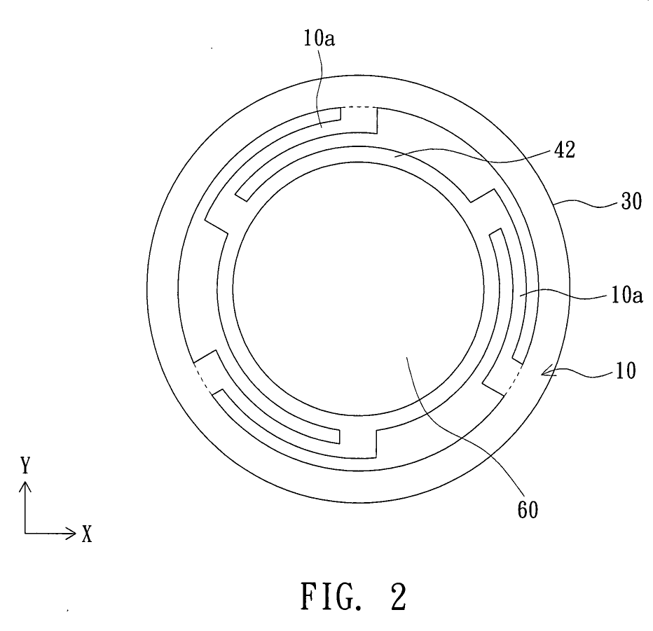

Referring to FIG. 2, an upward view of the camera module of FIG. 1 is shown. The first elastic plate 10 has several spiral arms 10a for enabling the movable wire-ring part 42 to be flexibly coupled to the housing 30 via the first elastic plate 10, such that the lens 60 can move upward/downward in the accommodation space 31. As indicated in FIG. 1, the elastic element preferably includes a second elastic plate 20. The second elastic plate 20 is for coupling the movable wire-ring part 42 and the housing 30. The first elastic plate 10 and the second elastic plate 20 are for flexibly clamping the movable wire-ring part 42 at the same time, such that the movable wire-ring part 42 is more firmly when moved in the accommodation space 31.

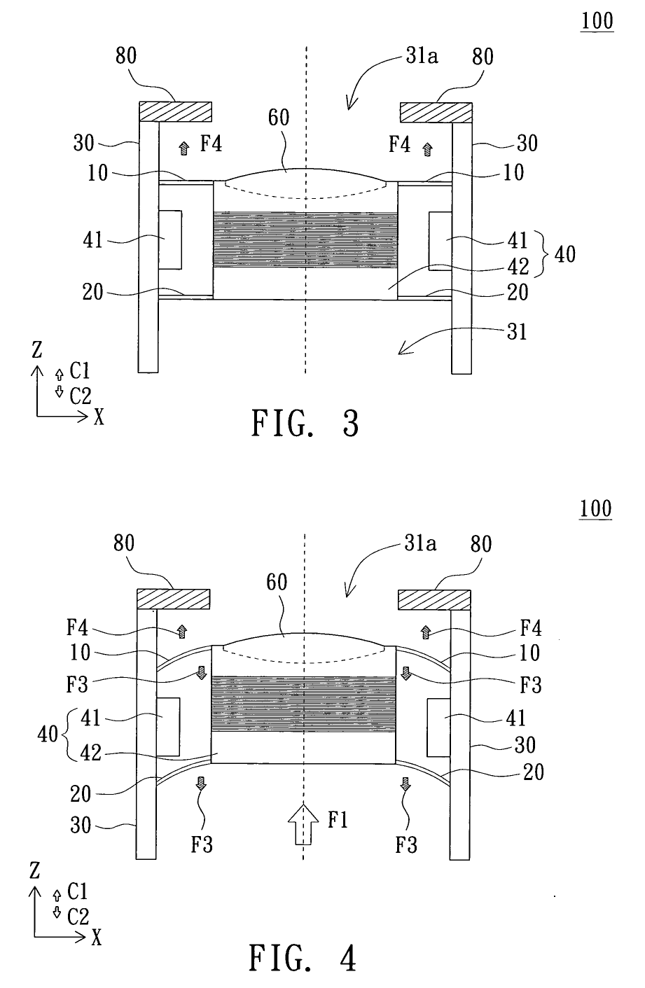

Referring to FIG. 3, a cross-sectional view of the camera module of FIG. 1 viewed along the cross-sectional line 2-2′ is shown. There is a magnetic force F4 existing between the magnetic element 80 and the first elastic plate 10. The magnetic element 80 has a para-magnetism and the first elastic plate 10 has a ferro-magnetism; or, the first elastic plate 10 has a ferro-magnetism and the magnetic element 80 has a para-magnetism; or, the first elastic plate 10 and the magnetic element 80 respectively have magnetically complementary ferro-magnetism. The ferro-magnetism is made from iron (Fe), cobalt (Co) or nickel (Ni), and the para-magnetism is made from iron, ferric oxide (Fe2O3), aluminum (Al) or sodium (Na). In the present embodiment of the invention, the magnetic element 80 is exemplified by a magnet, and the first elastic plate 10 is exemplified by an iron piece. The exemplified materials of the magnetic element 80 and the first elastic plate 10 are not for limiting the invention. Any design with a magnetic force F4 being generated between the magnetic element 80 and the first elastic plate 10 is within the scope of technology of the invention.

Referring to FIG. 4, a turned-on state of the voice coil motor of the camera module of FIG. 3 is shown. As an electric current E is inputted into the movable wire-ring part 42, according to Fleming's right-hand rule, the magnetic line (not illustrated) of the magnetic fixed part 41 of the voice coil motor 40 and the electric current E generate a pushing force F1 along a first direction C1. The pushing force F1 pushes the movable wire-ring part 42 to shift along the first direction C1 (that is, the Z direction toward the opening 31a). As the lens 60 is shifted along the first direction C1, the first elastic plate 10 and the second elastic plate 20 are deformed to generate an elastic restoring force F3 to counter against the pushing force F1. The elastic restoring force F3 is imposed on the movable wire-ring part 42 along a second direction C2 reverse to the first direction C1. As the pushing force F1 and the elastic restoring force F3 are balanced, the movable wire-ring part 42 is shifted to a pre-determined position.

The pushing force F1 is proportional to the volume fo the electric current E, that is, the higher the electric current E, the larger the pushing force F1. Moreover, the elastic restoring force F3 is positively related to the deformation of the first elastic plate 10 and the second elastic plate 20. As the shift made by the lens 60 in the first direction C1 increases, the deformation of the first elastic plate 10 and the second elastic plate 20 also increases accordingly, and so does the elastic restoring force F3. Therefore, as the shift made by the lens 60 along the first direction C1 increases, the camera module 100 must input a larger electric current E to generate a sufficient pushing force F1 to balance the elastic restoring force F3. In the present embodiment of the invention, the magnetic element 80 is disposed at the opening 31 a of the housing 30. As the lens 60 approaches the opening 31 a, the first elastic plate 10 becomes closer to the magnetic element 80. There is a magnetic force F4 existing between the magnetic element 80 and the first elastic plate 10. The magnetic force F4 and the pushing force F1 are together imposed on the lens 60 to balance the elastic restoring force F3. The magnetic force F4 largely reduces the load of the pushing force F1 and further brings down the required volume of the electric current E to be inputted, hence saving the power consumption.

### Second Embodiment

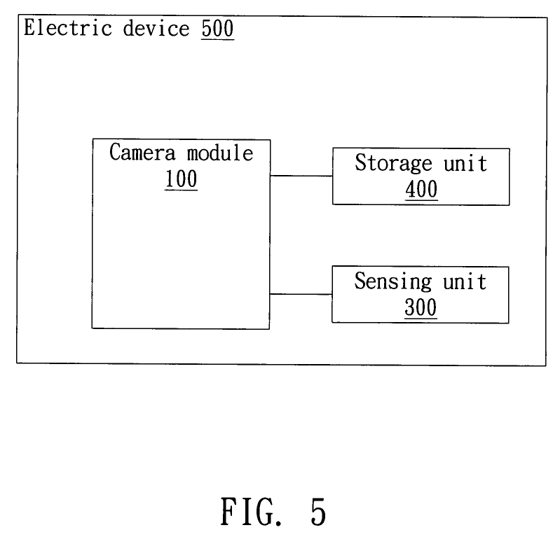

Referring to FIG. 5, a block diagram of an electric device according to a second embodiment of the invention is shown. The electric device 500 includes a camera module 100, a sensing unit 300 and a storage unit 400. The camera module 100 of the present embodiment of the invention adopts the camera module 100 of the first embodiment. As for other similarities, the same reference numbers are used and are not repeated here. The camera module 100 is applicable to various kinds of electric device 500, such as mobile communication device, notebook computer, camera or video recorder. The camera module 100 is disposed between the article and the sensing unit 300. The light of an article passes through the camera module 100 and forms an image on the sensing unit 300. The storage unit 400 is electrically connected to the sensing unit 300 for storing the image.

According to the camera module and the electric device using the same disclosed in the above embodiment of the invention, a magnetic element generates a magnetic force to drive the lens to shift towards the opening, such that the electric current required for generating the same pushing force is reduced, hence saving power consumption.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A camera module, comprising:
a lens;
a voice coil motor, comprising:
a movable wire-ring part for clamping the lens, wherein the movable wire-ring part has an elastic element; and
a magnetic fixed part disposed around the movable wire-ring part; and
a magnetic element;
wherein, as an electric current is inputted into the movable wire-ring part, the voice coil motor generates a force for pushing the movable wire-ring part to shift along a first direction, meanwhile, the elastic element imposes an elastic restoring force onto the movable wire-ring part along a reverse direction of the first direction, and the magnetic element imposes a magnetic force onto the movable wire-ring part along the first direction.

2. The camera module according to claim 1, wherein the elastic element has a first elastic plate.

3. The camera module according to claim 2, wherein the first elastic plate has a para-magnetism, and the magnetic element has a ferro-magnetism.

4. The camera module according to claim 2, wherein the first elastic plate has a ferro-magnetism, and the magnetic element has a para-magnetism.

5. The camera module according to claim 2, wherein the first elastic plate and the magnetic element respectively have magnetically complementary ferro-magnetism.

6. The camera module according to claim 2, wherein the camera module further comprises a housing, the elastic element further comprises a second elastic plate, and the movable wire-ring part is movably coupled to the housing via the second elastic plate.

7. The camera module according to claim 6, wherein the electric current is inputted into the movable wire-ring part via the first elastic plate and outputted to the movable wire-ring part via the second elastic plate.

8. The camera module according to claim 7, as the electric current ceases to be inputted into the conducting coil, the lens is moved by the elastic restoring force along the reverse direction of the first direction, and the magnetic force is smaller than the elastic restoring force.

9. An electric device, comprising:
a camera module, comprising:
a lens;
a voice coil motor, comprising:
a movable wire-ring part for clamping the lens, wherein the movable wire-ring part has an elastic element; and
a magnetic fixed part disposed around the movable wire-ring part; and
a magnetic element;
a sensing element disposed opposite to the lens, wherein an external light passes through the lens and forms an image on the sensing unit; and
a storage unit electrically connected to the sensing element for storing the image;
wherein, as an electric current is inputted into the movable wire-ring part, the voice coil motor generates a pushing force for pushing the movable wire-ring part to shift along a first direction, meanwhile, the elastic element imposes an elastic restoring force onto the movable wire-ring part along the reverse direction of the first direction, and the magnetic element imposes a magnetic force onto the movable wire-ring part along the first direction.

10. The electric device according to claim 9, wherein the elastic element has a first elastic plate.

11. The electric device according to claim 10, wherein the first elastic plate has a para-magnetism, and the magnetic element has a ferro-magnetism.

12. The electric device according to claim 10, wherein the first elastic plate has a ferro-magnetism, and the magnetic element has a para-magnetism.

13. The electric device according to claim 10, wherein the first elastic plate and the magnetic element respectively have magnetically complementary ferro-magnetism.

14. The electric device according to claim 10, wherein the camera module further comprises a housing, the elastic element further comprises a second elastic plate, and the movable wire-ring part is movably coupled to the housing via the second elastic plate.

15. The electric device according to claim 14, wherein the electric current is inputted into the movable wire-ring part via the first elastic plate and outputted to the movable wire-ring part via the second elastic plate.

16. The electric device according to claim 15, wherein as the electric current ceases to be inputted into the conducting coil, the lens is moved along the reverse direction of the first direction via the elastic restoring force, and the magnetic force is smaller than the elastic restoring force.

17. The electric device according to claim 9, being a mobile communication device.
